(19) United States
(12) Patent Application Publication
(10) Pub. No.: US 2025/0105426 A1
(43) Pub. Date: Mar. 27, 2025

(54) CELL-TO-PACK BATTERY

(71) Applicants: HYUNDAI MOTOR COMPANY, Seoul (KR); KIA CORPORATION, Seoul (KR)

(72) Inventors: Yu Ri Oh, Hwaseong-si (KR); Young Hoo Oh, Daejeon (KR); In Gook Son, Incheon (KR); Seok Eun Yoon, Seoul (KR)

(73) Assignees: HYUNDAI MOTOR COMPANY, Seoul (KR); KIA CORPORATION, Seoul (KR)

(21) Appl. No.: 18/615,964

(22) Filed: Mar. 25, 2024

(30) Foreign Application Priority Data
Sep. 26, 2023 (KR) 10-2023-0129674

(51) Int. Cl. H01M 50/271; H01M 50/262

(52) U.S. Cl. CPC H01M 50/271; H01M 50/262

(57) ABSTRACT

A cell-to-packet (CTP) battery has a simplified structure for surrounding a cell assembly, thereby reducing the number of components and the number of assembling and working processes. The CTP battery may include an integrated cover shaped to cover an upper surface and left and right surfaces of a cell assembly. The CTP battery may also include a clamp supported on a bottom surface of the cell assembly and connected between left and right panels of the integrated cover.

### CROSS-REFERENCE TO RELATED APPLICATION

The present application claims the benefit of and priority to Korean Patent Application No. 10-2023-0129674, filed Sep. 26, 2023, the entire contents of which are incorporated herein by this reference.

### TECHNICAL FIELD

The present disclosure relates to a cell-to-pack (CTP) battery in which a structure for surrounding a cell assembly is simplified.

### BACKGROUND

In general, in the case of a battery for an electric vehicle, a battery module is made by binding several battery cells, and a battery pack is made by binding several battery modules.

The battery cell is made by assembling secondary battery materials, such s positive electrode materials, negative electrode materials, separators, and electrolytes, in a casing made of a material such as aluminum. The battery module is made by binding several battery cells so that the battery cells may be protected from external impact.

Further, the battery pack is made by adding a battery management system (BMS), a cooling device, and the like in addition to several battery modules.

However, in the case of the battery pack, a process of connecting and surrounding the plurality of battery cells is required, which complicates a manufacturing process and increases costs.

A cell-to-pack (CTP) battery refers to a battery in which a single large unit module is configured and immediately used as a battery pack without the process of making several modules in a battery pack by using cells.

The CTP battery has an advantage in that a production process is simple and a physical size and shape of a battery pack may be efficiently designed.

In a typical structure of the CTP battery, endplates are provided at left and right sides of a cell assembly made by coupling several battery cells, and a top cover covers an upper portion of the cell assembly.

Further, an upper clamp is provided on an upper portion of the top cover and fixed between the left and right endplates, and a lower clamp is provided on a lower portion of the cell assembly and fixed between the left and right endplates, such that surface pressure of the cells is formed.

However, in the case of the battery structure, the endplate and the top cover are provided as separate components. Thus, an upper clamp component configured to couple the endplate and the top cover is additionally used, which increases the number of components and the number of assembling and working processes.

The foregoing is intended merely to aid in the understanding of the background of the present disclosure, and is not intended to mean that the present disclosure falls within the purview of the related art that is already known to those having ordinary skill in the art.

### SUMMARY

Embodiments of the present disclosure provide a CTP battery in which a structure for surrounding a cell assembly is simplified, thereby reducing the number of components and the number of assembling processes.

According to an embodiment, a CTP battery is provided. The CTP battery includes an integrated cover shaped to cover an upper surface and left and right surfaces of a cell assembly. The CTP battery also includes a clamp supported on a bottom surface of the cell assembly and connected between left and right panels of the integrated cover.

Endplates may overlap side panels provided at left and right sides of the integrated cover. Fixing portions formed at left and right sides of the clamp may be fixed in a state in which the fixing portions overlap the side panels and the endplates.

An endplate, among the endplates, may overlap an outer surface of a side panel among the side panels. A fixing portion, among the fixing portions, may be bent upward and joined by welding in a state in which the fixing portion overlaps an outer surface of the endplate.

A lower end of the side panel may extend downward to a portion where the side panel is joined to the fixing portion by welding.

A surface pressure forming portion formed at an upper end of an endplate, among the endplates, may extend toward an upper panel formed on an upper surface of the integrated cover and be fixed to the upper panel.

A seating groove portion having a shape corresponding to a front/rear length of the surface pressure forming portion may be formed on an upper surface of the upper panel. The surface pressure forming portion may be fixed in the seating groove portion.

The surface pressure forming portion may be provided as a plurality of surface pressure forming portions spaced apart from one another in a front/rear length direction of the endplate.

The surface pressure forming portions, among the plurality of surface pressure forming portions, may be provided symmetrically at front and rear sides based on an imaginary first center line extending leftward and rightward from a center of the upper panel.

The clamp may be provided as a plurality of clamps spaced apart from one another in a front/rear length direction of the endplate.

The clamps, among the plurality of clamps, may be provided symmetrically at front and rear sides based on an imaginary second center line extending upward and downward from a center of the endplate.

The CTP battery may further include front and rear covers shaped to cover front and rear surfaces of the cell assembly in which avoidance groove portions are formed in shapes made by partially cutting lower ends of the front and rear covers. A fixing portion of the clamp at a foremost side and a fixing portion of the clamp at the rearmost side are positioned and coupled in the avoidance groove portions.

According to embodiments of the present disclosure, the integrated cover is shaped to cover the upper surface and the left and right surfaces of the cell assembly. The integrated cover thus integrally implements not only the functions of the endplates disposed on the lateral surfaces of the cells and configured to provide surface pressure, but also the function of the housing of the module.

Therefore, the structure for surrounding the cell assembly is simplified, which reduces costs and weight by reducing the number of components and improves workability and product productivity by reducing the number of processes of assembling the battery pack.

Further, according to embodiments, because the side panel, together with the endplate, implements a double structure at the portion where the clamp is joined by welding, the cells are safely protected by the side panel even when the clamp is excessively welded and the endplate is punctured or damaged.

Moreover, according to embodiments, the plurality of clamps and the plurality of surface pressure forming portions are disposed to be spaced apart from one another in the front/rear length direction of the cell, thereby uniformly forming and maintaining the left and right surface pressure of the cells.

### BRIEF DESCRIPTION OF THE DRAWINGS

FIG. 1 is a view illustrating a CTP battery, according to embodiments of the present disclosure.

FIG. 2 is a view illustrating a state in which the CTP battery is disassembled, according to embodiments of the present disclosure.

FIG. 3 is an enlarged view illustrating cross-sectional shape of a lateral part of the battery, according to embodiments of the present disclosure.

FIG. 4 is a view illustrating a lateral shape of the CTP battery, according to embodiments of the present disclosure.

### DETAILED DESCRIPTION

Hereinafter, embodiments of the present disclosure are described in detail with reference to the accompanying drawings. The same or similar constituent elements are assigned with the same reference numerals regardless of reference numerals, and the repetitive description thereof has been omitted.

The suffixes ‘module’, ‘unit’, ‘part’, and ‘portion’ used to describe constituent elements in the following description are used together or interchangeably in order to facilitate the description, but the suffixes themselves do not have distinguishable meanings or functions.

In the description of the embodiments disclosed in the present specification, the specific descriptions of publicly known related technologies have been omitted when it was determined that the specific descriptions may obscure the subject matter of the present disclosure. In addition, it should be understood that the accompanying drawings are provided only to allow those having ordinary skill in the art to easily understand the embodiments disclosed in the present specification. The technical spirit of the present disclosure is not limited by the accompanying drawings. The present disclosure includes all alterations, equivalents, and alternatives that are included in the spirit and the technical scope of the present disclosure.

In describing the components of the embodiments of the present disclosure, terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, or an intervening constituent element can also be present between the constituent elements. When one constituent element is described as being “coupled directly to” or “connected directly to” another constituent element, it should be understood that no intervening constituent element is present between the constituent elements.

Singular expressions include plural expressions unless clearly described as different meanings in the context.

In the present specification, it should be understood that the terms “comprises,” “comprising,” “includes,” “including,” “containing,” “has,” “having” or other variations thereof are inclusive and therefore specify the presence of stated features, integers, steps, operations, elements, components, or combinations thereof, but do not preclude the presence or addition of one or more other features, integers, steps, operations, elements, components, or combinations thereof.

When a component, device, element, or the like of the present disclosure is described as having a purpose or performing an operation, function, or the like, the component, device, or element should be considered herein as being “configured to” meet that purpose or to perform that operation or function.

Hereinafter, embodiments of the present disclosure are described in detail with reference to the accompanying drawings.

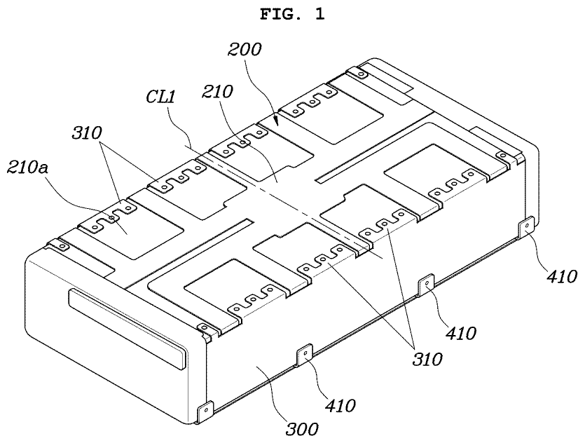

Referring to FIGS. 1-4, a CTP battery according to embodiments of the present disclosure includes an integrated cover 200 shaped to cover an upper surface and left and right surfaces of a cell assembly 100. The CTP battery also includes clamps 400 supported on a bottom surface of the cell assembly 100 and connected between left and right panels of the integrated cover 200.

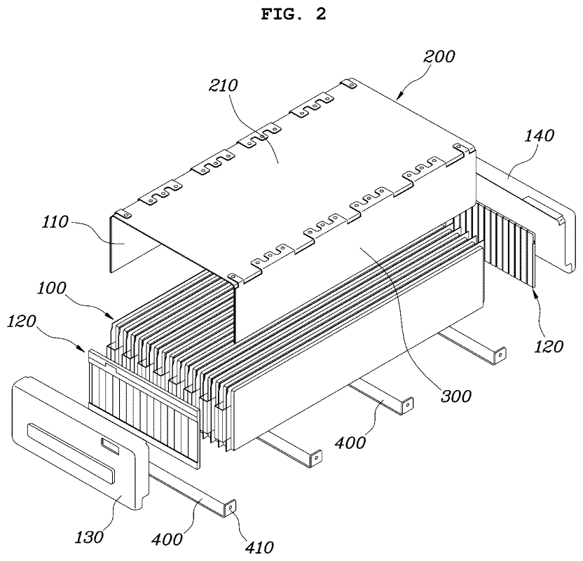

With reference to FIGS. 1 and 2, the cell assembly 100 is assembled by coupling several battery cells.

Sensor assemblies 120 for detecting states of the cells are connected to front and rear surfaces of the cell assembly 100.

Front and rear covers 130 and 140 are respectively assembled to front and rear surfaces of the sensor assembly 120.

In an example, the integrated cover 200 is formed in a ‘U’-shaped cross-sectional shape to cover the upper surface and the left and right surfaces of the cell assembly 100.

For example, an upper panel 210 is provided at a center of the integrated cover 200 and covers the upper surface of the cell assembly 100, and side panels 220 are bent downward from left and right ends of the upper panel 210 and cover the left and right surfaces of the cell assembly 100.

Further, the plurality of clamps 400 is supported on the bottom surface of the cell assembly 100, and two opposite ends of the clamp 400 are respectively fixed to a lower end of the left side panel 220 and a lower end of the right side panel 220.

Accordingly, the integrated cover 200 is shaped to cover the upper surface and the left and right surfaces of the cell assembly 100. Thus, according to embodiments, the integrated cover 200 serves as a housing of a module together with endplates 300 disposed on lateral surfaces of cells and configured to provide surface pressure.

Therefore, because the plurality of functions is implemented by the single component in an integrated manner, the structure for surrounding the cell assembly 100 is simplified, costs and weight are reduced by reducing the number of components, and workability and product productivity are improved by reducing the number of processes of assembling the battery pack.

Further, in embodiments of the present disclosure, the integrated cover 200 may be fixed in a state in which the endplates 300 overlap the side panels 220 formed at the left and right sides of the integrated cover 200. Furthermore, fixing portions 410 formed at left and right sides of the clamp 400 may overlap the side panels 220 and the endplates 300.

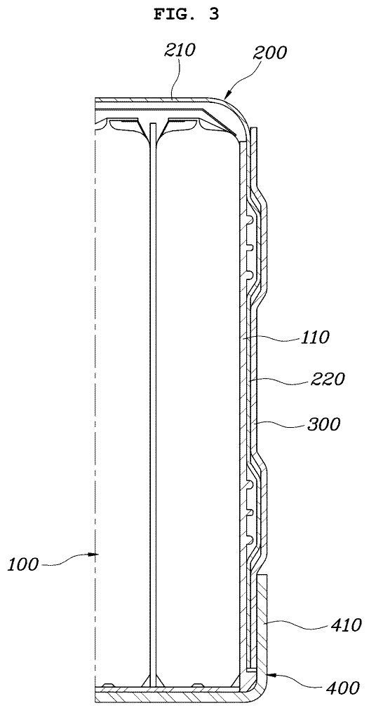

With reference to FIGS. 2 and 3, the endplate 300 is formed in a plate shape that covers the side panel 220, and the endplate 300 overlaps the side panel 220.

Further, the fixing portions 410 are bent upward from the left and right ends of the clamp 400 and fixed toward the cell assembly 100 outside portions where the fixing portions 410 overlap the endplates 300 and the side panels 220. Therefore, lateral surface pressure of the cell assembly

100 is more stably formed and maintained.

Further, according to embodiments of the present disclosure, the endplate 300 may overlap an outer surface of the side panel 220. The fixing portion 410 may be bent upward. The fixing portion 410 may be joined by welding in the state in which the fixing portion 410 overlaps an outer surface of the endplate 300.

For example, a lower end of the side panel 220 may extend downward to a portion where the side panel 220 is joined to the fixing portion 410 by welding.

Further, an inner cover 110 made of a plastic material may be embedded between the cell assembly 100 and the side panel 220.

Therefore, the portion where the clamp 400 is fixed is configured such that the clamp 400, the endplate 300, the side panel 220, the inner cover 110, and the cell assembly 100 are stacked in this order.

Accordingly, because the side panel 220, together with the endplate 300, implements a double structure, the cells are safely protected even when the clamp 400 is excessively welded and the endplate 300 is punctured or damaged.

According to embodiments of the present disclosure, surface pressure forming portions 310 formed at the upper end of the endplate 300 may extend toward the upper panel 210 formed on the upper surface of the integrated cover 200 and be fixed to the upper panel 210.

With reference to FIGS. 1 and 2, the surface pressure forming portions 310 are formed at the upper end of the endplate 300.

The surface pressure forming portion 310 may be bent in a shape covering an edge portion of the upper end of the integrated cover 200 that defines a boundary between the upper panel 210 and the side panel 220. The surface pressure forming portion 310 may be joined to the upper surface of the upper panel 210 by welding. Therefore, upper surface pressure of the cells is stably

formed and maintained by the surface pressure forming portions 310.

Further, as illustrated in FIG. 1, according to embodiments of the present disclosure, seating groove portions 210a, each having a shape corresponding to a front/rear length of the surface pressure forming portion 310, are formed on the upper surface of the upper panel 210. The surface pressure forming portions 310 may be fixed in the seating groove portions 210a.

For example, a front/rear length of the surface pressure forming portion 310 may be equal to a front/rear length of the seating groove portion 210a, or may be smaller than the front/rear length of the seating groove portion 210a within an error range.

Therefore, the positions of the surface pressure forming portions 310 may be conveniently selected. Thus, the performance in fixing the endplate 300 may be improved because forward and rearward motions of the endplate 300 relative to the integrated cover 200 may be restricted during the process of fixing the surface pressure forming portions 310.

Further, according to embodiments of the present disclosure, the plurality of surface pressure forming portions 310 may be disposed to be spaced apart from one another in the front/rear length direction of the endplate 300.

For example, with reference to FIG. 1, the surface pressure forming portions 310 may be provided symmetrically at front and rear sides based on an imaginary first center line extending leftward and rightward from the center of the upper panel 210.

In embodiments, because a length of the cell in the forward/rearward direction increases, there is a desire to uniformize left and right surface pressure of the cells as well as the front and rear surface pressure of the cells.

Therefore, the plurality of surface pressure forming portions 310 may be disposed to be spaced apart from one another symmetrically based on the first center line in the front/rear length direction of the cell, thereby uniformizing the left and right surface pressure as well as the front and rear surface pressure of the cells.

According to embodiments of the present disclosure, the plurality of clamps 400 may be disposed to be spaced apart from one another in the front/rear length direction of the endplate 300.

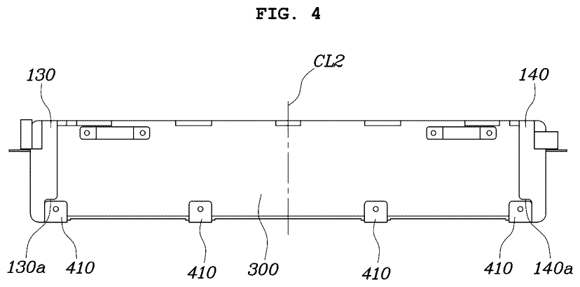

For example, with reference to FIG. 4, the clamps 400 may be provided symmetrically at front and rear sides based on an imaginary second center line extending upward and downward from the center of the endplate 300.

In embodiments, because the length of the cell in the forward/rearward direction increases as described above, there is a desire to uniformize the left and right surface pressure of the cells.

Therefore, the four clamps 400 may be disposed to be spaced apart from one another symmetrically based on the second center line in the front/rear length direction of the cell, thereby uniformizing the left and right surface pressure of the cells.

In embodiments, the CTP battery may further include the front and rear covers 130 and 140 shaped to cover the front and rear surfaces of the cell assembly 100. Avoidance groove portions 130a and 140a are formed by partially cutting out lower ends of the front and rear covers 130 and 140, such that the fixing portion 410 of the clamp 400 at the foremost side and the fixing portion 410 of the clamp 400 at the rearmost side may be positioned and coupled in the avoidance groove portions 130a and 140a.

With reference to FIG. 4, the avoidance groove portions 130a and 140a are respectively formed in shapes made by partially cutting, in an ‘L’ shape, a part of the lower end of the front cover 130 and a part of the lower end of the rear cover 140.

Therefore, the fixing portion 410 of the clamp 400 at the foremost side is positioned in the avoidance groove portion 130a formed in the front cover 130 and fixed to the front end of the endplate 300.

Further, the fixing portion 410 of the clamp 400 at the rearmost side is positioned in the avoidance groove portion 140a formed in the rear cover 140 and fixed to the rear end of the endplate 300.

Therefore, the left and right surface pressure is formed at the foremost and rearmost portions of the cells as well as the middle portion of the cells, such that the left and right surface pressure of the cells may be more uniformly formed.

As described above, according to embodiments of the present disclosure, the integrated cover 200 is shaped to cover the upper surface and the left and right surfaces of the cell assembly 100 and integrally implements not only the functions of the endplates 300 disposed on the lateral surfaces of the cells and configured to provide surface pressure but also the function of the housing of the module.

Therefore, the structure for surrounding the cell assembly 100 is simplified, which reduces costs and weight by reducing the number of components and improves workability and product productivity by reducing the number of processes of assembling the battery pack.

Further, because the side panel 220, together with the endplate 300, implements a double structure at the portion where the clamp 400 is joined by welding, the cells are safely protected by the side panel 220 even though the clamp 400 is excessively welded and the endplate 300 is punctured or damaged.

Moreover, the plurality of clamps 400 and the plurality of surface pressure forming portions 310 are disposed to be spaced apart from one another in the front/rear length direction of the cell, thereby uniformly forming and maintaining the left and right surface pressure of the cells.

While the present disclosure has been described with reference to the specific examples, it should be apparent to those having ordinary skill in the art that various modifications and alterations may be made within the technical spirit of the present disclosure, and these modifications and alterations are included in the scope of the appended claims.

What is claimed is:

1. A cell-to-pack (CTP) battery, comprising:
an integrated cover shaped to cover an upper surface and left and right surfaces of a cell assembly; and
at least one clamp supported on a bottom surface of the cell assembly and connected between left and right panels of the integrated cover.

2. The CTP battery of claim 1, wherein:
endplates overlap side panels provided at left and right sides of the integrated cover; and
fixing portions formed at left and right sides of the at least one clamp are fixed in a state in which the fixing portions overlap the side panels and the endplates.

3. The CTP battery of claim 2, wherein:
an endplate, among the endplates, overlaps an outer surface of a side panel among the side panels; and
a fixing portion, among the fixing portions, is bent upward and joined by welding in a state in which the fixing portion overlaps an outer surface of the endplate.

4. The CTP battery of claim 3, wherein a lower end of the side panel extends downward to a portion where the side panel is joined to the fixing portion by welding.

5. The CTP battery of claim 2, wherein a surface pressure forming portion formed at an upper end of an endplate, among the endplates, extends toward an upper panel formed on an upper surface of the integrated cover and is fixed to the upper panel.

6. The CTP battery of claim 5, wherein:
a seating groove portion having a shape corresponding to a front/rear length of the surface pressure forming portion is formed on an upper surface of the upper panel; and
the surface pressure forming portion is fixed in the seating groove portion.

7. The CTP battery of claim 5, wherein the surface pressure forming portion is provided as a plurality of surface pressure forming portions spaced apart from one another in a front/rear length direction of the endplate.

8. The CTP battery of claim 7, wherein the surface pressure forming portions, among the plurality of surface pressure forming portions, are provided symmetrically at front and rear sides based on an imaginary first center line extending leftward and rightward from a center of the upper panel.

9. The CTP battery of claim 2, wherein the at least one clamp comprises a plurality of clamps, and clamps of the plurality of clamps are spaced apart from one another in a front/rear length direction of an endplate among the endplates.

10. The CTP battery of claim 9, wherein the clamps, among the plurality of clamps, are provided symmetrically at front and rear sides based on an imaginary second center line extending upward and downward from a center of the endplate.

11. The CTP battery of claim 10, further comprising:
front and rear covers shaped to cover front and rear surfaces of the cell assembly,
wherein avoidance groove portions are formed by partially cutting lower ends of the front and rear covers, and wherein a fixing portion of the at least one clamp at a foremost side and a fixing portion of the at least one clamp at a rearmost side are positioned and coupled in the avoidance groove portions.
